(19) United States
(12) Patent Application Publication
(10) Pub. No.: US 2020/0250238 A1
(43) Pub. Date: Aug. 6, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Yifan ZHANG, Kanagawa (JP)

(73) Assignee: FUJI XEROX CO., LTD., Tokyo (JP)

(21) Appl. No.: 16/551,734

(22) Filed: Aug. 27, 2019

(30) Foreign Application Priority Data
Jan. 31, 2019 (JP) 2019-015799

(51) Int. Cl. G06F 16/903; G06F 16/901

(52) U.S. Cl. CPC G06F 16/90348; G06F 16/90344; G06F 16/9017

(57) ABSTRACT

An information processing apparatus includes a searching unit, an identifying unit, and an extracting unit. The searching unit searches for multiple cells from a table having cells arranged in a matrix. The multiple cells contain character strings that at least partially match a character string input as a key by a user. The identifying unit identifies a header range expressing a header row and a header column in the table based on distribution of the multiple cells found by the searching unit. The extracting unit extracts values corresponding to key cells by regarding the multiple cells included in the header range identified by the identifying unit as the key cells.

### CROSS-REFERENCE TO RELATED APPLICATIONS

This application is based on and claims priority under 35 USC 119 from Japanese Patent Application No. 2019-015799 filed Jan. 31, 2019.

### BACKGROUND

### (i) Technical Field

The present disclosure relates to information processing apparatuses and non-transitory computer readable media.

### (ii) Related Art

For example, Japanese Unexamined Patent Application Publication No. 2016-91081 discloses a system that imports a format of a form. This system extracts a candidate block, in which a title registered in a block extraction policy and an attribute match, from blocks of a form to be imported, and displays the extracted candidate block together with the matching rate on a display unit. The system receives an input of the candidate block selected by the user from the displayed blocks and the matching rate, and outputs, to a block library, a definition file based on the received candidate block. The definition file is based on block definition in which template block definition of the definition file of the form to be imported is created.

In a case where values with respect to all keys included in a table are to be extracted, it is necessary to identify a header range that includes all of the keys. In this case, the relationship between all of the keys and the header range has to be defined in advance. However, it is not easy to define all of the keys included in the table.

### SUMMARY

Aspects of non-limiting embodiments of the present disclosure relate to an information processing apparatus and a non-transitory computer readable medium with which a key included in a table and a value corresponding to the key are extractable without having to define all keys included in the table.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a searching unit, an identifying unit, and an extracting unit. The searching unit searches for multiple cells from a table having cells arranged in a matrix. The multiple cells contain character strings that at least partially match a character string input as a key by a user. The identifying unit identifies a header range expressing a header row and a header column in the table based on distribution of the multiple cells found by the searching unit. The extracting unit extracts values corresponding to key cells by regarding the multiple cells included in the header range identified by the identifying unit as the key cells.

### BRIEF DESCRIPTION OF THE DRAWINGS

Exemplary embodiments of the present disclosure will be described in detail based on the following figures, wherein:

FIG. 1 is a block diagram illustrating an example of an electrical configuration of an information processing apparatus according to a first exemplary embodiment;

FIG. 2 is a block diagram illustrating an example of a functional configuration of the information processing apparatus according to the first exemplary embodiment;

FIG. 3 is a flowchart illustrating an example of the flow of a process performed in accordance with an extraction program according to the first exemplary embodiment;

FIG. 4 illustrates an example of an input table according to the exemplary embodiment;

FIG. 5 is a flowchart illustrating an example of the flow of a header-range identifying process according to the first exemplary embodiment;

FIG. 6 illustrates an example of combinations of rows and columns that may serve as a header range according to the first exemplary embodiment;

FIG. 7 illustrates an example of a first header range candidate according to the first exemplary embodiment;

FIG. 8 illustrates an example of a second header range candidate according to the first exemplary embodiment;

FIG. 9 illustrates an example of a third header range candidate according to the first exemplary embodiment;

FIG. 10 illustrates an example of a third header range candidate in a one-dimensional table and a two-dimensional table according to the first exemplary embodiment;

FIG. 11 is a diagram used for explaining a key-cell-value extracting process according to the first exemplary embodiment;

FIG. 12 is a block diagram illustrating an example of a functional configuration of an information processing apparatus according to a second exemplary embodiment;

FIG. 13 is a flowchart illustrating an example of the flow of a header-range identifying process according to the second exemplary embodiment; and

FIG. 14 is a diagram used for explaining the header-range identifying process according to the second exemplary embodiment.

### DETAILED DESCRIPTION

Exemplary embodiments of the present disclosure will be described below with reference to the drawings.

### First Exemplary Embodiment

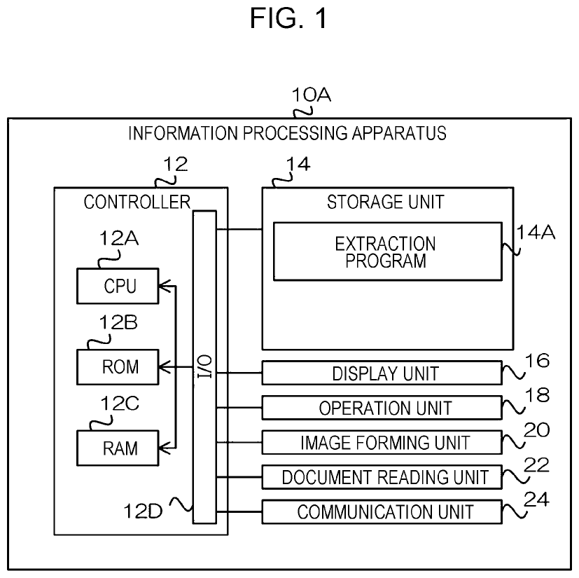

FIG. 1 is a block diagram illustrating an example of an electrical configuration of an information processing apparatus 10A according to a first exemplary embodiment.

As shown in FIG. 1, the information processing apparatus 10A according to this exemplary embodiment includes a controller 12, a storage unit 14, a display unit 16, an operation unit 18, an image forming unit 20, a document reading unit 22, and a communication unit 24.

The information processing apparatus may be, for example, an image forming apparatus, a personal computer (PC), a smartphone, or a tablet terminal.

The controller 12 includes a central processing unit (CPU) 12A, a read-only memory (ROM) 12B, a random access memory (RAM) 12C, and an input/output interface (I/O) 12D, which are connected to one another via a bus.

The I/O 12D is connected to various functional units, including the storage unit 14, the display unit 16, the operation unit 18, the image forming unit 20, the document reading unit 22, and the communication unit 24. These functional units are communicable with the CPU 12A via the I/O 12D.

The controller 12 may be constituted of a second controller that partially controls the operation of the information processing apparatus 10A, or may be constituted of a part of a first controller that entirely controls the operation of the information processing apparatus 10A. The blocks of the controller 12 may partially or entirely be, for example, an integrated circuit (IC), such as a large-scale integrated (LSI) circuit, or an IC chip set. The blocks may be individual circuits or may partially or entirely be an integrated circuit. The blocks may be integrated with each other, or one or some of the blocks may be separately provided. In each of the blocks, a part thereof may be separately provided. The integration of the controller 12 is not limited to LSI and may be a dedicated circuit or a general-purpose processor.

The storage unit 14 is, for example, a hard disk drive (HDD), a solid state drive (SSD), or a flash memory. The storage unit 14 stores therein an extraction program 14A for realizing a table-data extraction function according to this exemplary embodiment. The extraction program 14A may alternatively be stored in the ROM 12B.

The extraction program 14A may be preinstalled in, for example, the information processing apparatus 10A. The extraction program 14A may be realized by being stored in a nonvolatile storage medium or by being distributed via a network, and by being installed in the information processing apparatus 10A, where appropriate. Examples of the nonvolatile storage medium include a compact disc read-only memory (CD-ROM), a magneto-optical disk, an HDD, a digital versatile disc read-only memory (DVD-ROM), a flash memory, and a memory card.

The display unit 16 is, for example, a liquid crystal display (LCD) or an organic electroluminescence (EL) display. The display unit 16 integrally has a touchscreen. The operation unit 18 is provided with various types of control keys, such as a numerical keypad and a start key. The display unit 16 and the operation unit 18 receives various types of commands from a user of the information processing apparatus 10A. Examples of the various types of commands include a command for starting a document reading process and a command for starting a document copying process. The display unit 16 displays various types of information, such as a result of a process executed in accordance with a command received from the user and a notification about a process.

The document reading unit 22 fetches documents one-by-one from a feed tray of an automatic document feeder (not shown) provided at the upper section of the information processing apparatus 10A and optically reads each fetched document so as to obtain image information. Alternatively, the document reading unit 22 optically reads a document placed on a document tray, such as platen glass, so as to obtain image information.

The image forming unit 20 forms an image onto a recording medium, such as paper, based on the image information obtained as a result of the reading process performed by the document reading unit 22 or image information obtained from, for example, an external PC connected via a network. Although electrophotography is described as an example of an image forming method in this exemplary embodiment, another method, such as an inkjet method, may be employed as an alternative.

If the image forming method is electrophotography, the image forming unit 20 includes a photoconductor drum, a charging unit, an exposure unit, a developing unit, a transfer unit, and a fixing unit. The charging unit applies voltage to the photoconductor drum so as to electrostatically charge the surface of the photoconductor drum. The exposure unit exposes the photoconductor drum electrostatically charged by the charging unit with light according to the image information, so as to form an electrostatic latent image on the photoconductor drum. The developing unit develops the electrostatic latent image formed on the photoconductor drum by using toner, so as to form a toner image on the photoconductor drum. The transfer unit transfers the toner image formed on the photoconductor drum onto a recording medium. The fixing unit applies heat and pressure onto the toner image transferred on the recording medium so as to fix the toner image thereon.

The communication unit 24 is connected to a network, such as the Internet, a local area network (LAN), or a wide area network (WAN), and is communicable with, for example, an external PC via the network.

The information processing apparatus 10A according to this exemplary embodiment has an optical character recognition (OCR) function and performs a character recognition process on the image contained in the image information so as to convert the image into a character code.

As mentioned above, in a case where values with respect to all keys included in a table are to be extracted, it is necessary to identify a header range including all of the keys. In this case, the relationship between all of the keys and the header range has to be defined in advance.

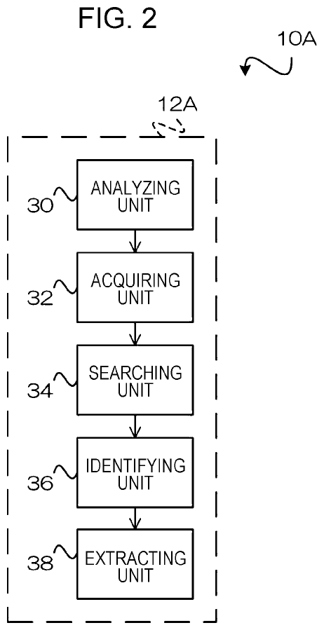

Therefore, the CPU 12A of the information processing apparatus 10A according to this exemplary embodiment loads the extraction program 14A stored in the storage unit 14 onto the RAM 12C and executes the extraction program 14A, thereby functioning as the units shown in FIG. 2.

FIG. 2 is a block diagram illustrating an example of a functional configuration of the information processing apparatus 10A according to the first exemplary embodiment.

As shown in FIG. 2, the CPU 12A of the information processing apparatus 10A according to this exemplary embodiment functions as an analyzing unit 30, an acquiring unit 32, a searching unit 34, an identifying unit 36, and an extracting unit 38.

The analyzing unit 30 according to this exemplary embodiment acquires a table input as a result of a reading process performed by the document reading unit 22 or a table input from, for example, an external PC, and performs a table structure analysis on the acquired table. The table to be processed in this exemplary embodiment is a table having cells arranged in a matrix, and may or may not have frame borders. In this table structure analysis, table structure information containing the number of rows and the number of columns in the table and the layout of the table is acquired. A known technique is used in this table structure analysis. If the table is electronic data and the table structure information is added to the electronic data, the table structure information may be acquired from the electronic data.

The acquiring unit 32 according to this exemplary embodiment acquires the contents of the cells included in the table. In detail, the acquiring unit 32 acquires character strings within the cells. For example, if the table is input as image data as a result of a reading process performed by the document reading unit 22, a character recognition process is performed on the image data so that a character string is acquired from each cell. A character string in this case includes one or more characters and may include a numeric character or a symbol. If the table is input as electronic data of a predetermined data format from, for example, an external PC, the electronic data may be analyzed so that a character string is acquired from each cell.

The searching unit 34 according to this exemplary embodiment searches through the input table for multiple cells containing character strings that at least partially match a character string input as a key by the user. A key in the table refers to an item to be extracted by the user from multiple items included in the table and is expressed as a character string. Furthermore, a cell expressing a key is defined as a key cell, and all key cells are included in a header range of the table. The header range may include not only a key cell to be extracted by the user, but also a character-string cell simply expressing an item.

The identifying unit 36 according to this exemplary embodiment identifies the header range expressing a header row and a header column in the table based on the distribution of the multiple cells found by the searching unit 34.

The extracting unit 38 according to this exemplary embodiment extracts values corresponding to key cells by regarding the multiple cells included in the header range identified by the identifying unit 36 as the key cells.

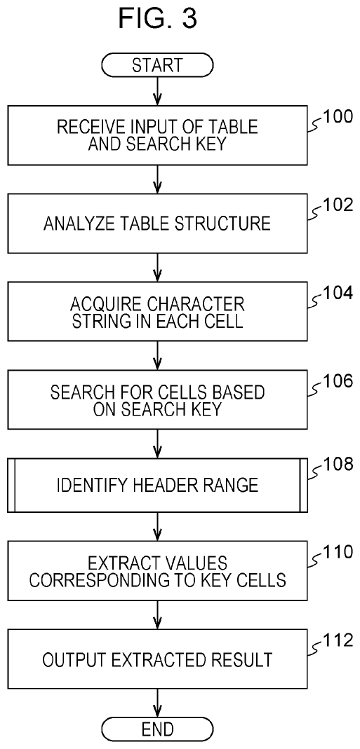

Next, the operation of the information processing apparatus 10A according to the first exemplary embodiment will be described with reference to FIG. 3.

FIG. 3 is a flowchart illustrating an example of the flow of a process performed in accordance with the extraction program 14A according to the first exemplary embodiment.

First, when the information processing apparatus 10A is commanded to activate the extraction program 14A, the following steps are executed.

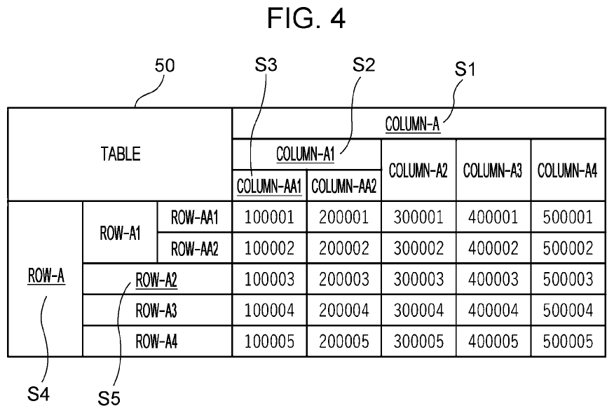

In step 100 in FIG. 3, the analyzing unit 30 receives an input of a table shown in FIG. 4 as an example. The searching unit 34 receives an input of a character string as a search key from a user in correspondence with the received input table.

FIG. 4 illustrates an example of an input table 50 according to this exemplary embodiment.

A header range in the input table 50 shown in FIG. 4 includes a column-A cell, a column-A1 cell, a column-AA1 cell, a column-AA2 cell, a column-A2 cell, a column-A3 cell, a column-A4 cell, a row-A cell, a row-A1 cell, a row-AA1 cell, a row-AA2 cell, a row-A2 cell, a row-A3 cell, a row-A4 cell, and a table cell. The table cell is an example of a character-string cell simply expressing an item.

In the input table 50 shown in FIG. 4, a character string of a search key input by the user corresponds to multiple cells S1 to S5 (i.e., five cells in the example in FIG. 4). In FIG. 4, the multiple cells S1 to S5 are underlined so that the multiple cells S1 to S5 are readily distinguishable from other cells.

In step 102, the analyzing unit 30 performs a table structure analysis on the input table 50 shown in FIG. 4 as an example, so as to acquire table structure information containing the number of rows and the number of columns in the table and the layout of the table. In the case of the input table 50 shown in FIG. 4, it is analyzed that the table has eight rows (row numbers 1 to 8 are not shown) and eight columns (column numbers 1 to 8 are not shown). The direction of the same rows (i.e., the horizontal direction) is defined as a “row direction”, and the direction of the same columns (i.e., the vertical direction) is defined as a “column direction”. Each cell is expressed by using a row number and a column number. For example, the column-AA1 cell is expressed as a row-3 column-4 cell. A combined cell constituted of two or more combined cells has information about a row number and a column number prior to combination. For example, the column-A cell is a combined cell and has information about a row-1 column-4 cell, a row-1 column-5 cell, a row-1 column-6 cell, a row-1 column-7 cell, and a row-1 column-8 cell. Therefore, the column-A cell is expressed as at least one of the row-i column-4 cell, the row-1 column-5 cell, the row-1 column-6 cell, the row-1 column-7 cell, and the row-1 column-8 cell.

In step 104, the acquiring unit 32 uses the table structure information acquired in step 102 to acquire a character string in each cell included in the input table 50 shown in FIG. 4 as an example.

In step 106, the searching unit 34 searches through, for example, the input table 50 shown in FIG. 4 for multiple cells based on the search key received in step 100. In detail, the searching unit 34 compares the character string in each cell acquired in step 104 with the character string received as a search key in step 100, and searches for multiple cells containing character strings that at least partially match the character string of the search key. In the case of the input table 50 shown in FIG. 4, the multiple cells S1 to S5 are found. As shown in FIG. 4, the multiple cells found by the searching unit 34 are distributed in the row direction and the column direction of the header range. Moreover, the number of multiple cells found by the searching unit 34 is smaller than the number of key cells included in the header range.

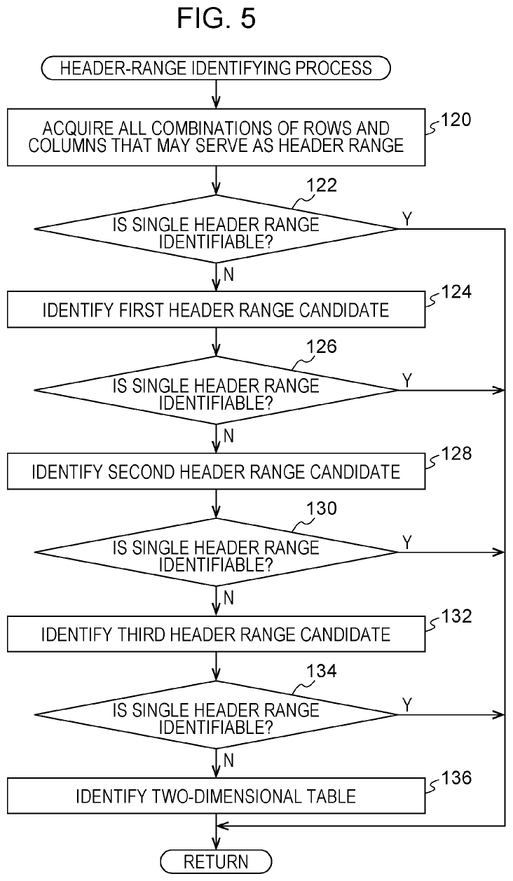

In step 108, the identifying unit 36 identifies the header range expressing header rows and header columns of the input table 50 shown in FIG. 4 as an example based on the distribution of the multiple cells found in step 106. A specific header-range identifying process in step 108 will be described here with reference to FIG. 5.

FIG. 5 is a flowchart illustrating an example of the flow of the header-range identifying process according to the first exemplary embodiment.

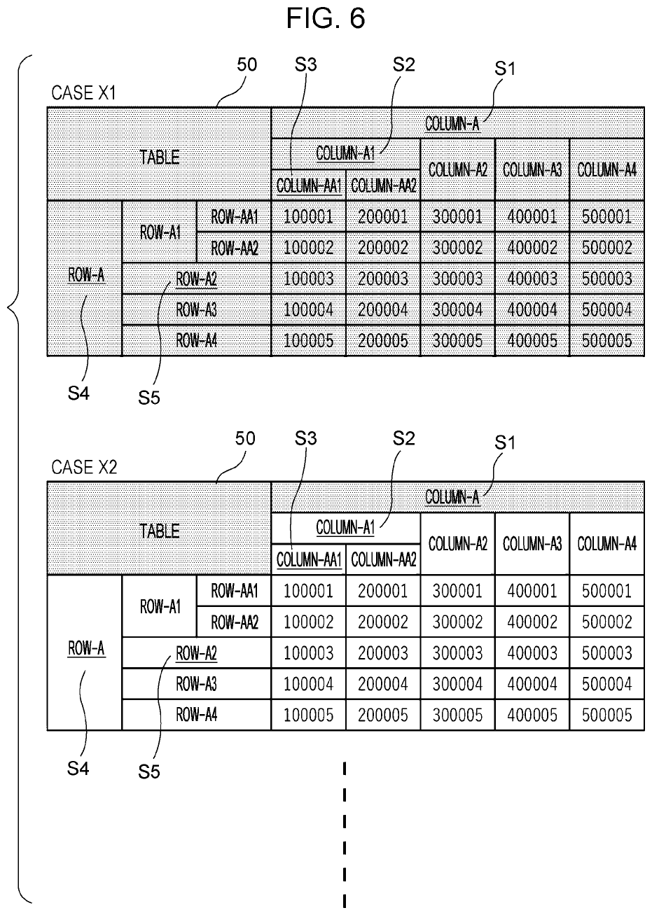

First, in step 120 in FIG. 5, the identifying unit 36 acquires all combinations of rows and columns that may serve as a header range in the input table 50 shown in FIG. 4 as an example. In the case of the input table 50 shown in FIG. 4, all combinations of rows and columns expressed using the row numbers 1 to 8 and the column numbers 1 to 8 are acquired. A specific example of combinations of rows and columns that may serve as a header range will be described here with reference to FIG. 6.

FIG. 6 illustrates an example of combinations of rows and columns that may serve as a header range according to the first exemplary embodiment.

Each grey area shown in FIG. 6 indicates a combination of rows and columns that may serve as a header range.

A case X1 shown in FIG. 6 indicates a state where all cells in the input table 50 are selected as a header-range candidate. In other words, the case X1 indicates all combinations of the row numbers 1 to 8 and the column numbers 1 to 8. A case X2 shown in FIG. 6 indicates a state where the table cell and the column-A cell are selected as a header-range candidate. In other words, the case X2 indicates a combination of the row number 1 and the column numbers 1 to 8, a combination of the row number 2 and the column numbers 1 to 3, and a combination of the row number 3 and the column numbers 1 to 3. The case X1 and the case X2 are examples, and all combinations of row numbers and column numbers that may serve as a header range are acquired in step 120.

In step 122, it is determined whether or not a single header range is identifiable by the identifying unit 36. If it is determined that a single header range is identifiable (i.e., if a positive determination result is obtained), the process proceeds to the returning step. If it is determined that a single header range is not identifiable (i.e., if a negative determination result is obtained), the process proceeds to step 124.

In step 124, the identifying unit 36 identifies a first header range candidate from all combinations of rows and columns that may serve as a header range, acquired in step 120. The first header range candidate is expressed as a combination including the multiple cells found by the searching unit 34. A specific example of the first header range candidate will be described here with reference to FIG.

7.

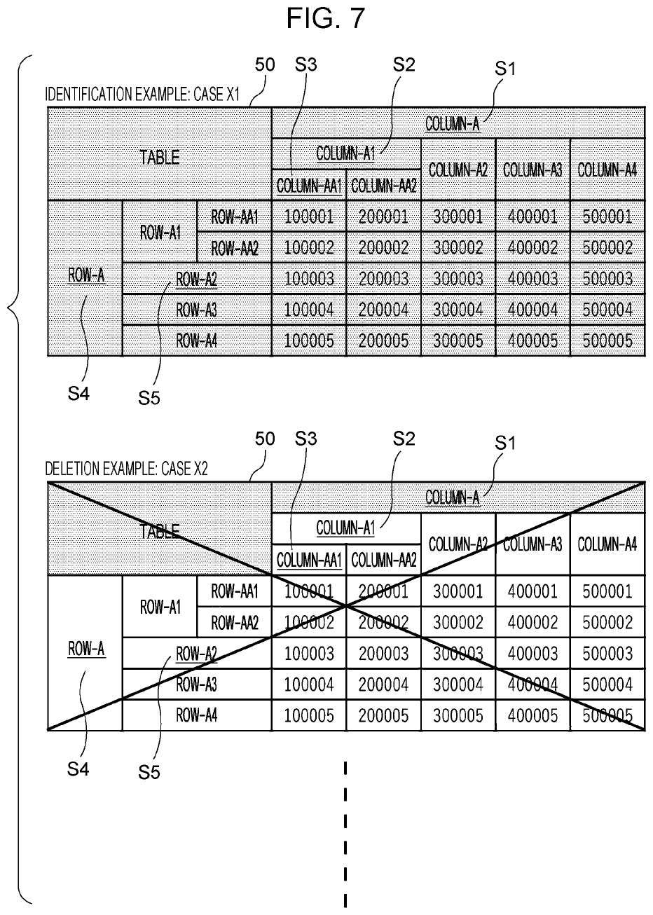

FIG. 7 illustrates an example of the first header range candidate according to the first exemplary embodiment.

Each grey area shown in FIG. 7 indicates a combination of rows and columns that may serve as a header range, similar to FIG. 6 described above.

A case X1 shown in FIG. 7 indicates an example of a combination including the multiple cells S1 to S5 found based on the search key input by the user. This case X1 is identified as the first header range candidate. A case X2 shown in FIG. 7 is deleted since the cell S2, the cell S3, the cell S4, and the cell S5 of the multiple cells S1 to S5 are not included. In other words, a case where not all of the multiple cells S1 to S5 are included is deleted.

In step 126, it is determined whether or not a single header range is identifiable by the identifying unit 36. If it is determined that a single header range is identifiable (i.e., if a positive determination result is obtained), the process proceeds to the returning step. If it is determined that a single header range is not identifiable (i.e., if a negative determination result is obtained), the process proceeds to step 128.

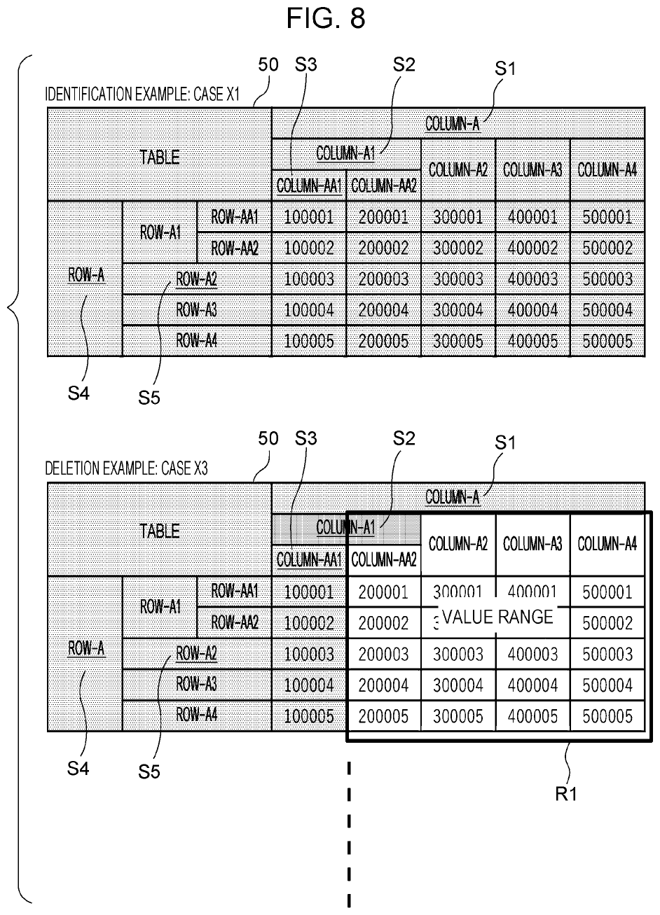

In step 128, the identifying unit 36 identifies a second header range candidate from the first header range candidate identified in step 124. The second header range candidate is expressed as a combination including at least one of a row and a column where a first cell serving as any of the multiple cells found by the searching unit 34 exists. An example of the first cell is a combined cell constituted of two or more combined cells. A specific example of the second header range candidate will be described here with reference to FIG. 8.

FIG. 8 illustrates an example of the second header range candidate according to the first exemplary embodiment.

Each grey area shown in FIG. 8 indicates a combination of rows and columns that may serve as a header range, similar to FIG. 6 described above. A range R1 shown in FIG. 8 indicates a value range as a value candidate.

A case X1 shown in FIG. 8 indicates an example of a combination including rows and columns where the cell S1, the cell S2, the cell S4, and the cell S5 as an example of first cells exist. The case X1 is identified as the second header range candidate. A case X2 shown in FIG. 8 is deleted since not all of the rows and columns where the cell S2 exists are included, that is, since the cell S2 is partially included in the value range R1 in the case X2. In other words, a case where not all of the rows and columns where the cell S1, the cell S2, the cell S4, and the cell S5 exist are included is deleted. In the example shown in FIG. 8, the cell S1 exists in column 4 to column 8 and in row 1. The cell S2 exists in column 4 and column 5 and in row 2. The cell S4 exists in row 4 to row 8 and in column 1. The cell S5 exists in row 6 and in column 2 and column 3.

In step 130, it is determined whether or not a single header range is identifiable by the identifying unit 36. If it is determined that a single header range is identifiable (i.e., if a positive determination result is obtained), the process proceeds to the returning step. If it is determined that a single header range is not identifiable (i.e., if a negative determination result is obtained), the process proceeds to step 132.

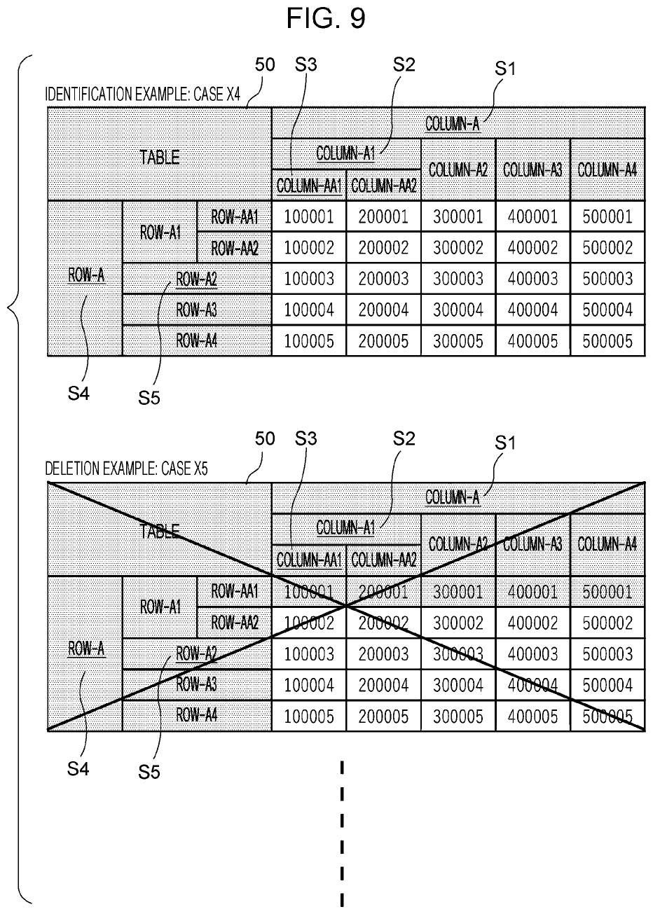

In step 132, the identifying unit 36 identifies a third header range candidate having a minimum number of cells from the second header range candidate identified in step 128. A specific example of the third header range candidate will be described here with reference to FIG. 9.

FIG. 9 illustrates an example of the third header range candidate according to the first exemplary embodiment.

Each grey area shown in FIG. 9 indicates a combination of rows and columns that may serve as a header range, similar to FIG. 6 described above.

A case X4 shown in FIG. 9 indicates an example of a combination including rows and columns having a minimum number of cells. This case X4 is identified as the third header range candidate. A case X5 shown in FIG. 9 is deleted due to not being a combination including rows and columns having a minimum number of cells.

In step 134, it is determined whether or not a single header range is identifiable by the identifying unit 36. If it is determined that a single header range is identifiable (i.e., if a positive determination result is obtained), the process proceeds to the returning step. If the third header range candidate is identified as multiple combinations of one-dimensional tables and two-dimensional tables, that is, if it is determined that a single header range is not identifiable (i.e., if a negative determination result is obtained), the process proceeds to step 136.

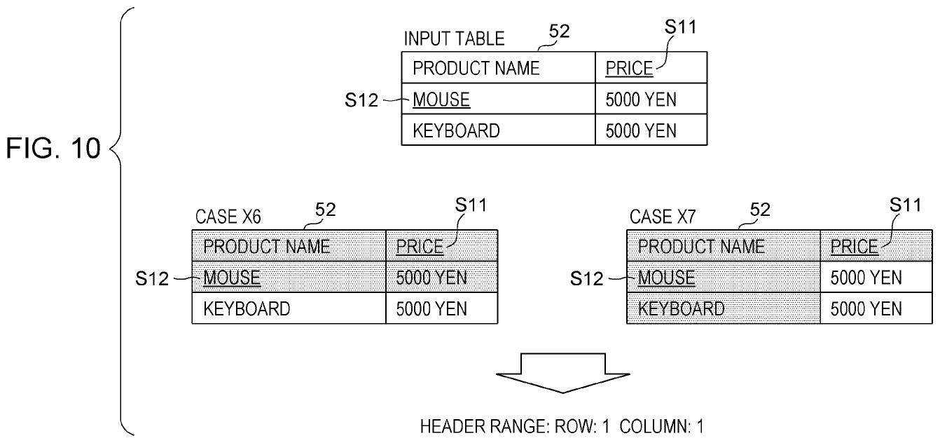

In step 136, the identifying unit 36 identifies a third header range candidate in a two-dimensional table as a header range, and the process proceeds to the returning step. A specific example of a third header range candidate in a one-dimensional table and a two-dimensional table will be described here with reference to FIG. 10.

FIG. 10 illustrates an example of a third header range candidate in a one-dimensional table and a two-dimensional table according to the first exemplary embodiment.

Each grey area shown in FIG. 10 indicates a combination of rows and columns that may serve as a header range, similar to FIG. 6 described above.

In an input table 52 shown in FIG. 10, the search key input by the user corresponds to a cell S11 and a cell S12. In the example shown in FIG. 10, a case X6 and a case X7 having the same number of cells, namely, four cells, exist as third header range candidates, such that it is not possible to identify a single header range. The case X6 corresponds to a one-dimensional table, and the case X7 corresponds to a two-dimensional table. In this case, the case X7 corresponding to the two-dimensional table is identified as a header range. In other words, a row-1 column-1 cell, a row-1 column-2 cell, a row-2 column-1 cell, and a row-3 column-1 cell are identified as a header range. If there are multiple third header range candidates, the multiple third header range candidates may be presented to the user, so as to allow the user to select any one of the third header range candidates as a header range.

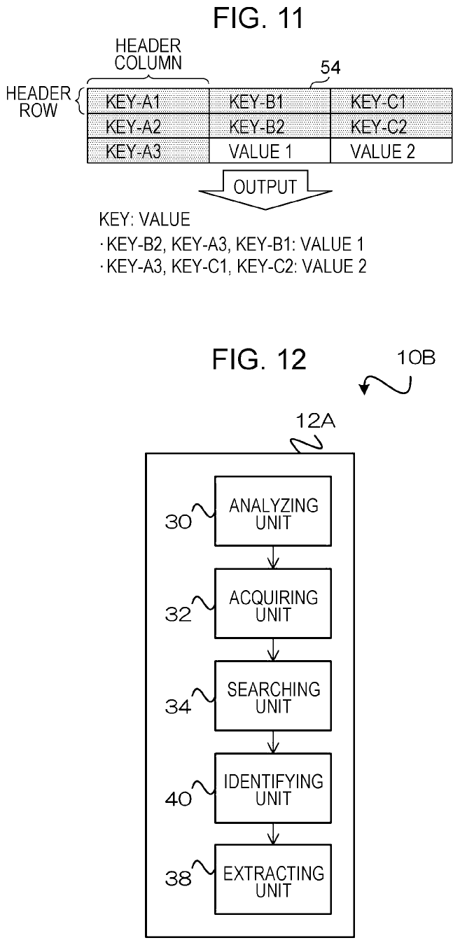

Referring back to FIG. 3, in step 110, the extracting unit 38 extracts values corresponding to key cells by regarding the multiple cells included in the header range identified as a result of the header-range identifying process described above as the key cells. A process for extracting a value corresponding to each key cell will be described here with reference to FIG. 11.

FIG. 11 is a diagram used for explaining the key-cell-value extracting process according to the first exemplary embodiment.

A grey area shown in FIG. 11 indicates a combination of rows and columns identified as a header range.

A header range 54 shown in FIG. 11 includes a key-A1 cell, a key-B1 cell, a key-C1 cell, a key-A2 cell, a key-B2 cell, a key-C2 cell, and a key-A3 cell. In the case of the example shown in FIG. 11, all of the cells existing in the header range 54 are determined as being key cells. A value corresponding to each key cell is extracted by using the row number and the column number of the key cell.

In detail, a “value 1” in row 3 and column 2 is extracted in correspondence with a row-2 column-2 key-B2 cell, a row-3 column-1 key-A3 cell, and a row-1 column-2 key-B1 cell. Moreover, a “value 2” in row 3 and column 3 is extracted in correspondence with row-3 column-1 key-A3 cell, a row-1 column-3 key-C1 cell, and a row-2 column-3 key-C2 cell.

In step 112, the extracting unit 38 outputs the extracted result described above to the storage unit 14 as an example, and ends the process according to the extraction program 14A.

According to this exemplary embodiment, a header range is identified from a range that includes multiple cells containing character strings that at least partially match a character string input as a key by a user. Therefore, a header range is identified without having to preliminarily define the relationship between all keys and a header range, and keys included in a table and values corresponding to the keys are extracted.

### Second Exemplary Embodiment

The first exemplary embodiment relates to a case where a header range is identified from a range that includes multiple cells containing character strings that at least partially match a character string input as a key by a user. This exemplary embodiment relates to a case where a header range is identified from a rectangular region that does not include multiple cells containing character strings that at least partially match a character string input as a key by a user.

A CPU 12A of an information processing apparatus 10B according to this exemplary embodiment loads an extraction program 14A stored in a storage unit 14 to a RAM 12C and executes the extraction program 14A, thereby functioning as units shown in FIG. 12.

FIG. 12 is a block diagram illustrating an example of a functional configuration of the information processing apparatus 10B according to the second exemplary embodiment.

As shown in FIG. 12, the CPU 12A of the information processing apparatus 10B according to this exemplary embodiment functions as an analyzing unit 30, an acquiring unit 32, a searching unit 34, an identifying unit 40, and an extracting unit 38. Components having functions identical to those in the information processing apparatus 10A according to the first exemplary embodiment are given the same reference signs, and redundant descriptions will be omitted here.

The identifying unit 40 according to this exemplary embodiment identifies a rectangular region that includes a predetermined reference cell of a table and a diagonal cell located diagonally to the reference cell and that does not include multiple cells found by the searching unit 34 in the row direction and the column direction. In the identified rectangular region, the identifying unit 40 identifies a range excluding a rectangular region having a maximum number of cells as a header range from the table.

For example, the reference cell is located at the lower right corner of the table, and the diagonal cell is located diagonally at the upper left side of the cell located at the lower right corner.

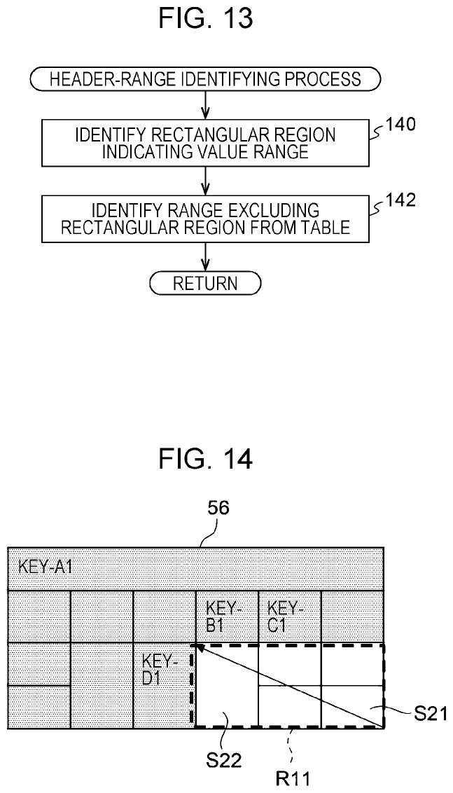

Next, the operation of the information processing apparatus 10B according to the second exemplary embodiment will be described with reference to FIG. 3 described above and FIG. 13.

In this exemplary embodiment, only the header-range identifying process in step 108 shown in FIG. 3 described above is different. Therefore, the header-range identifying process will be described in detail with reference to FIG. 13.

FIG. 13 is a flowchart illustrating an example of the flow of the header-range identifying process according to the second exemplary embodiment.

First, in step 140 in FIG. 13, the identifying unit 40 identifies a rectangular region indicating a value range in an input table 56 shown in FIG. 14 as an example.

FIG. 14 is a diagram used for explaining the header-range identifying process according to the second exemplary embodiment.

The input table 56 shown in FIG. 14 includes a key-B1 cell, a key-C1 cell, and a key-D1 cell as multiple cells found by the searching unit 34.

In the input table 56 shown in FIG. 14, a reference cell S21 is located at the lower right corner as an example, and a diagonal cell S22 is located diagonally at the upper left side as an example. A rectangular region having a maximum number of cells is identified from a rectangular region (i.e., a value range) that includes the reference cell S21 and the diagonal cell S22 and that does not include the key-B1 cell, the key-C1 cell, and the key-D1 cell. The location of the reference cell S21 is not limited to the lower right corner of the rectangular region. The reference cell S21 may alternatively be located at the lower left corner, the upper right corner, or the upper left corner of the rectangular region.

In step 142, the identifying unit 40 identifies the range excluding the rectangular region identified in step 140 as a header range from the input table 56 shown in FIG. 14 as an example, and returns to step 110 shown in FIG. 3 described above.

According to this exemplary embodiment, a header range is identified from a rectangular region that does not include multiple cells containing character strings that at least partially match a character string input as a key by a user. Therefore, a header range is identified without having to preliminarily define the relationship between all keys and a header range, and keys included in a table and values corresponding to the keys are extracted.

As an alternative, the exemplary embodiment may be a program for causing a computer to execute the functions of the units included in the information processing apparatus. As another alternative, the exemplary embodiment may be a computer-readable storage medium storing the program.

The configuration of the information processing apparatus described in each of the above-described exemplary embodiments is an example and may be modified in accordance with the circumstances within the scope of the disclosure.

Furthermore, the flow of the process of the program described in each of the above-described exemplary embodiments is also an example. An unnecessary step or steps may be deleted, a new step or steps may be added, or the processing sequence may be interchanged within the scope of the disclosure.

In each of the above-described exemplary embodiments, the process according to the exemplary embodiment is realized in accordance with software by using a computer. Alternatively, for example, the process may be realized by hardware or by a combination of hardware and software.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a searching unit that searches for a plurality of cells from a table having cells arranged in a matrix, the plurality of cells containing character strings that at least partially match a character string input as a key by a user;
an identifying unit that identifies a header range expressing a header row and a header column in the table based on distribution of the plurality of cells found by the searching unit; and
an extracting unit that extracts values corresponding to key cells by regarding the plurality of cells included in the header range identified by the identifying unit as the key cells.

2. The information processing apparatus according to claim 1,
wherein the identifying unit identifies a first header range candidate expressed as a combination including the plurality of cells found by the searching unit from all combinations of rows and columns that may serve as the header range in the table,
wherein the identifying unit identifies a second header range candidate from the identified first header range candidate, the second header range candidate being expressed as a combination including at least one of a row and a column where a first cell serving as any of the plurality of cells found by the searching unit exists, and
wherein if a third header range candidate having a minimum number of cells is identified as a single combination from the identified second header range candidate, the identifying unit sets the third header range candidate as the header range.

3. The information processing apparatus according to claim 2,
wherein if the third header range candidate is identified as a plurality of combinations of a one-dimensional table and a two-dimensional table, the identifying unit sets the third header range candidate of the two-dimensional table as the header range.

4. The information processing apparatus according to claim 2,
wherein the first cell is a combined cell constituted of two or more combined cells.

5. The information processing apparatus according to claim 3,
wherein the first cell is a combined cell constituted of two or more combined cells.

6. The information processing apparatus according to claim 1,
wherein, in a rectangular region that includes a predetermined reference cell of the table and a diagonal cell located diagonally to the reference cell and that does not include the plurality of cells found by the searching unit in a row direction and a column direction, the identifying unit identifies, from the table, a range excluding a rectangular region having a maximum number of cells as the header range.

7. The information processing apparatus according to claim 6,
wherein the reference cell is a cell located at a lower right corner of the table, and
wherein the diagonal cell is a cell located diagonally at an upper left side of the cell located at the lower right corner.

8. The information processing apparatus according to claim 1,
wherein the plurality of cells found by the searching unit are distributed in a row direction and a column direction of the header range.

9. The information processing apparatus according to claim 2,
wherein the plurality of cells found by the searching unit are distributed in a row direction and a column direction of the header range.

10. The information processing apparatus according to claim 3,
wherein the plurality of cells found by the searching unit are distributed in a row direction and a column direction of the header range.

11. The information processing apparatus according to claim 4,
wherein the plurality of cells found by the searching unit are distributed in a row direction and a column direction of the header range.

12. The information processing apparatus according to claim 5,
wherein the plurality of cells found by the searching unit are distributed in a row direction and a column direction of the header range.

13. The information processing apparatus according to claim 6,
wherein the plurality of cells found by the searching unit are distributed in the row direction and the column direction of the header range.

14. The information processing apparatus according to claim 7,
wherein the plurality of cells found by the searching unit are distributed in the row direction and the column direction of the header range.

15. The information processing apparatus according to claim 8,
wherein the number of the plurality of cells found by the searching unit is smaller than the number of key cells included in the header range.

16. A non-transitory computer readable medium storing a program causing a computer to execute a process, the process comprising:
searching for a plurality of cells from a table having cells arranged in a matrix, the plurality of cells containing character strings that at least partially match a character string input as a key by a user;
identifying a header range expressing a header row and a header column in the table based on distribution of the plurality of cells; and
extracting values corresponding to key cells by regarding the plurality of cells included in the header range as the key cells.

17. An information processing apparatus comprising:
searching means for searching for a plurality of cells from a table having cells arranged in a matrix, the plurality of cells containing character strings that at least partially match a character string input as a key by a user;
identifying means for identifying a header range expressing a header row and a header column in the table based on distribution of the plurality of cells found by the searching means; and
extracting means for extracting values corresponding to key cells by regarding the plurality of cells included in the header range identified by the identifying means as the key cells.
